(19) United States
(12) Patent Application Publication
(10) Pub. No.: US 2025/0014033 A1
(43) Pub. Date: Jan. 9, 2025

(54) STORAGE MEDIUM FOR TERMINAL DEVICE, INFORMATION PROCESSING DEVICE, AND METHOD FOR OPERATING SYSTEM

(71) Applicant: TOYOTA JIDOSHA KABUSHIKI KAISHA, Toyota-shi (JP)

(72) Inventors: Yasunori NANYA, Nagoya-shi (JP); Yuzo YAMADA, Nagoya-shi (JP)

(73) Assignee: TOYOTA JIDOSHA KABUSHIKI KAISHA, Toyota-shi (JP)

(21) Appl. No.: 18/643,506

(22) Filed: Apr. 23, 2024

(30) Foreign Application Priority Data
Jul. 6, 2023 (JP) 2023-111727

(51) Int. Cl. G06Q 20/40

(52) U.S. Cl. CPC G06Q 20/401

(57) ABSTRACT

A non-transitory storage medium stores a program for the terminal device, and the program is executed by a control unit of the terminal device, so that the control unit outputs information for an interface that prompts the user to use the payment service provided by the operator, and sends the authentication information of the user input in response to the interface to an information processing device that executes processing for the payment service, and when another service provided by the operator is presented on the interface and an instruction to apply for use of the other service is received, the authentication information is sent to the information processing device.

### CROSS-REFERENCE TO RELATED APPLICATION

This application claims priority to Japanese Patent Application No. 2023-111727 filed on Jul. 6, 2023, incorporated herein by reference in its entirety.

### BACKGROUND

### 1. Technical Field

The present disclosure relates to a storage medium for a terminal device, an information processing device, and a method for operating a system.

### 2. Description of Related Art

In recent years, various means for payment such as payment using a credit card and mobile payment using a terminal device such as a smartphone have been widely used, and technologies for assisting these payment means have been proposed. For example, Japanese Unexamined Patent Application Publication No. 2019-145071 (JP 2019-145071 A) discloses a system for assisting application for a membership of a credit card.

### SUMMARY

There is room for improvement in convenience for a user who uses various payment means.

The present disclosure relates to a storage medium for a terminal device, etc. that can improve convenience for a user who uses various payment means.

According to the present disclosure, a storage medium stores a program for a terminal device.

The program is executed by a control unit of the terminal device to cause the control unit to: output information for an interface configured to prompt a user to use a payment service provided by a business operator;
send authentication information of the user that is input according to the interface to an information processing device configured to perform a process for the payment service; and send the authentication information to the information processing device when another service provided by the business operator is presented on the interface and an instruction to apply for use of the other service is received.

An information processing device according to the present disclosure includes:
a communication unit; and
a control unit configured to perform communication by using the communication unit.
   The control unit is configured to:
receive, from a terminal device including an interface configured to prompt a user to use a payment service provided by a business operator, authentication information of the user that is input according to the interface, and perform a process for the payment service; and receive the authentication information sent from the terminal device in response to an instruction to apply for use of another service provided by the business operator when the other service is presented on the interface, and perform a process for permitting the user to use the other service.

A method for operating a system according to the present disclosure is a method for operating a system including a terminal device and an information processing device configured to communicate with each other. The method includes:
outputting, by the terminal device, information for an interface configured to prompt a user to use a payment service provided by a business operator, and sending authentication information of the user that is input according to the interface;
receiving, by the information processing device, the authentication information of the user and performing a process for the payment service;
sending, by the terminal device, the authentication information when another service provided by the business operator is presented on the interface and an instruction to apply for use of the other service is received by the terminal device; and
receiving, by the information processing device, the authentication information and performing a process for permitting the user to use the other service.

With the storage medium for the terminal device, etc. of the present disclosure, it is possible to improve the convenience for the user who uses various payment means.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram illustrating a configuration example of an information processing system;

FIG. 2 is a diagram illustrating an example of an operation procedure of the information processing system;

FIG. 3 is a diagram illustrating an example of an operation sequence of the information processing system; and

FIG. 4 is a diagram illustrating an exemplary application interface.

### DETAILED DESCRIPTION OF EMBODIMENTS

Hereinafter, embodiments will be described with reference to the drawings.

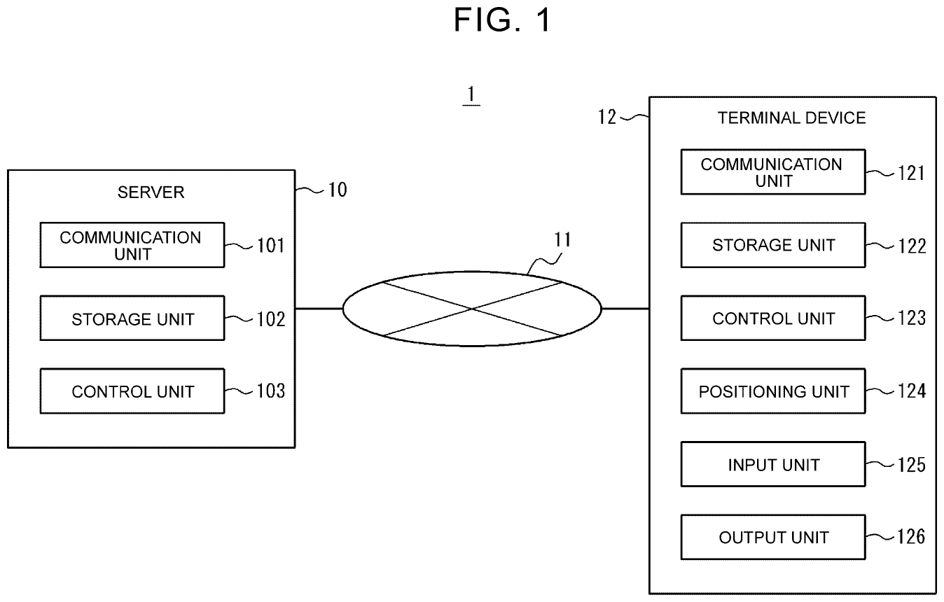

FIG. 1 is a diagram showing a configuration example of an information processing system according to the embodiment. The information processing system 1 includes one or more server devices 10 and one or more terminal devices 12. One or more of the server device 10 and the terminal device 12 are connected to each other via the network 11 so as to be able to communicate information with each other.

The server device 10 is, for example, a server computer belonging to a cloud computing system or other computing systems and functioning as a server implemented with various functions. The server device 10 may be configured by two or more server computers that are connected to each other so as to be capable of information communication and operate in cooperation with each other. The server device 10 corresponds to the “information processing device” in the present embodiment. The “information processing device” in the present embodiment executes information processing for a service such as settlement provided by a business operator such as a financial business (hereinafter, simply referred to as a business operator).

The terminal device 12 is a terminal device carried by a user, and the terminal device has a communication function and is configured to execute various information processing. The terminal device 12 is, for example, a smartphone, a smart watch, a wearable terminal, or the like.

The network 11 is, for example, the Internet, but includes a mobile communication network, an ad hoc network, a Local Area Network (LAN), a Metropolitan Area Network (MAN), or other network, or any combination thereof.

The information processing system 1 supports use by a user of a service such as settlement provided by a business operator. The payment service includes so-called mobile payment. The mobile settlement includes a process in which the terminal device 12 reads information necessary for settlement at a store or the like and causes the store terminal to read the information. Alternatively, the mobile approval includes a step in which the terminal device 12 transmits and receives information necessary for the settlement by the short-range wireless communication of the non-contact type with the shop terminal. The mobile approval is executed based on the authentication information of the user, and the authentication information of the user is provided from the terminal device 12 to the server device 10. Other services of the payment service include services such as credit payment using a credit card provided by an operator, loan borrowing, purchase of goods, and the like. The terminal device 12 includes an application program for using a payment service. The terminal device 12 provides the user with an interface for using the payment service by executing the application program. Such an interface (hereinafter referred to as an application interface) includes a screen including an operation menu of an application program, voice guidance, and the like.

The terminal device 12 outputs information for the application interface, and the application interface prompts the user to execute the mobile payment service provided by the operator. The terminal device 12 receives and transmits authentication information of the user input in accordance with the application interface. The server device 10 receives the authentication information of the user and executes processing for the mobile payment service. Other services provided by the operator, for example, services such as credit settlement, loan borrowing, purchase of goods, and the like, are presented in the application interface, and when the terminal device 12 receives an instruction to apply for use of the service, the terminal device 12 transmits authentication information. The server device 10 receives the authentication information and executes a process for permitting the user to use another service. When the user inputs the authentication information at a time in the application interface when the user uses the mobile payment service, the user transmits the authentication information stored in the terminal device 12 to the server device 10 even if the user does not input the authentication information again when the user applies for use of the other service, thereby enabling processing for use of the other service. Therefore, a complicated time and effort of the user inputting the authentication information a plurality of times is omitted, and the convenience of the user can be improved.

The respective configurations of the server device 10 and the terminal device 12 will be described in detail.

The server device 10 includes a communication unit 101, a storage unit 102, and a control unit 103. When the server device 10 is configured by two or more server computers, these configurations are appropriately arranged in two or more computers.

The communication unit 101 includes one or more communication interfaces. The communication interface is, for example, a LAN interface. The communication unit 101 receives information used for the operation of the server device 10. Further, the communication unit 101 transmits information obtained by the operation of the server device 10. The server device 10 is connected to the network 11 by the communication unit 101, and performs information communication with the terminal device 12 via the network 11.

The storage unit 102 functions as, for example, a main storage device, an auxiliary storage device, or a cache memory. The storage unit 102 includes one or more semiconductor memories, one or more magnetic memories, one or more optical memories, or a combination of at least two of these. Semiconductor memories are, for example, Random Access Memory (RAM) or Read Only Memory (ROM). RAM is, for example, Static RAM (SRAM) or Dynamic RAM (DRAM). ROM is, for example, Electrically Erasable Programmable ROM (EEPROM). The storage unit 102 stores information used for the operation of the server device 10 and information obtained by the operation of the server device 10.

The control unit 103 includes one or more processors, one or more dedicated circuits, or a combination thereof. The processor may be, for example, a general-purpose processor such as Central Processing Unit (CPU) or a special-purpose processor such as a Graphics Processing Unit (GPU) specialized for a particular process. The dedicated circuitry is, for example, Field-Programmable Gate Array (FPGA), Application Specific Integrated Circuit (ASIC), etc. The control unit 103 executes information processing related to the operation of the server device 10 while controlling each unit of the server device 10.

The function of the server device 10 is realized by executing a control program by a processor included in the control unit 103. That is, the control program is a program for causing the computer to function as the server device 10. Some or all of the functions of the server device 10 may be realized by a dedicated circuit included in the control unit 103. The control program may be stored in a non-transitory recording medium or a storage medium readable by the server device 10, and may be read from the medium by the server device 10.

The terminal device 12 includes a communication unit 121, a storage unit 122, a control unit 123, a positioning unit 124, an input unit 125, and an output unit 126.

The communication unit 121 includes a communication module corresponding to a wired or wireless LAN standard, a Long Term Evolution (LTE), 4th Generation (4G), or 5th Generation (5G), a module corresponding to a mobile communication standard, a short-range wireless communication module, or the like. The terminal device 13 is connected to the network 11 by the communication unit 121 via a neighboring router device or a mobile communication base station. The terminal device 13 performs information communication with another device via the network 11, or performs information communication directly with another device.

The storage unit 122 includes one or more semiconductor memories, one or more magnetic memories, one or more optical memories, or a combination of at least two of these. The semiconductor memory is, for example, a RAM or a ROM. The RAM is, for example, a static random access memory (SRAM) or a dynamic random access memory (DRAM). The ROM is, for example, an EEPROM. The storage unit 122 functions as, for example, a main storage device, an auxiliary storage device, or a cache memory. The storage unit 122 stores information used for the operation of the control unit 123 and information obtained by the operation of the control unit 123.

The control unit 123 includes one or more general-purpose processors such as CPU, Micro Processing Unit (MPU), or one or more special-purpose processors specialized for a particular process. Alternatively, the control unit 123 may include one or more dedicated circuitry such as a FPGA, ASIC. The control unit 123 comprehensively controls the operation of the terminal device 13 by operating in accordance with a control program or a processing program, or by operating in accordance with an operation procedure implemented as a circuit. Then, the control unit 123 transmits and receives various kinds of information to and from the server device 10 and the like via the communication unit 121, and executes the operation according to the present embodiment.

Positioning unit 124 includes one or more Global Navigation Satellite System (GNSS) receivers. GNSS includes, for example, at least one of Global Positioning System (GPS), Quasi-Zenith Satellite System (QZSS), BeiDou, Global Navigation Satellite System (GLONASS), and Galileo. The positioning unit 124 acquires the position information of the terminal device 12 and sends the position information to the control unit 123.

The input unit 125 includes one or more input interfaces. The input-interface includes, for example, a physical key, a capacitive key, a pointing device, a touch screen integrally provided with the display, a camera that captures captured images or image codes, or a IC card reader. The input interface may include a microphone that accepts audio input. The input unit 125 receives an input of information used for the operation of the control unit 123, and sends the input information to the control unit 123.

The output unit 126 includes one or more output interfaces. The output interface is, for example, a display or a speaker. The display is, for example, an LCD or an organic EL display. The output unit 126 outputs information obtained by the operation of the control unit 123.

The function of the control unit 123 is realized by the processor included in the control unit 123 executing the control program. The control program is a program for causing the processor to function as the control unit 123. In addition, some or all of the functions of the control unit 123 may be realized by a dedicated circuit included in the control unit 123.

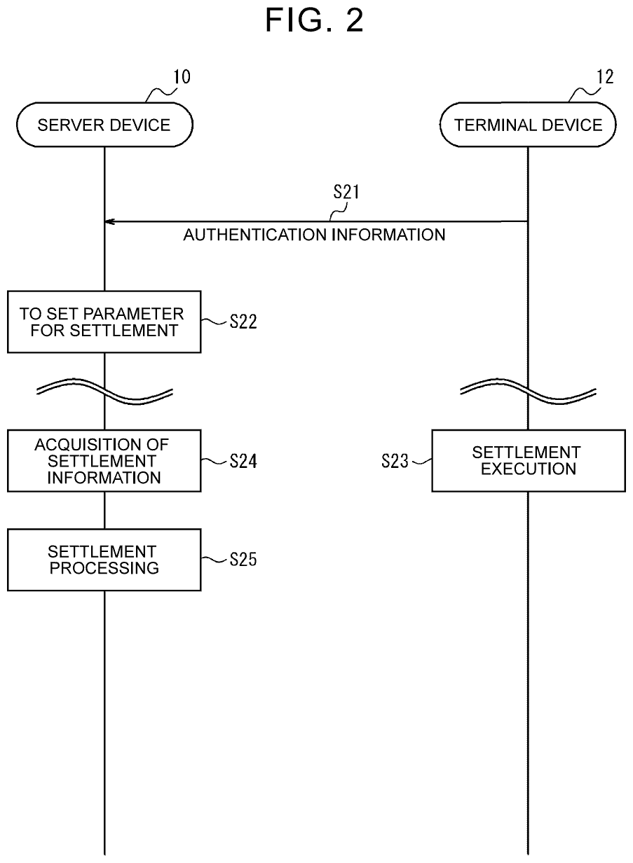

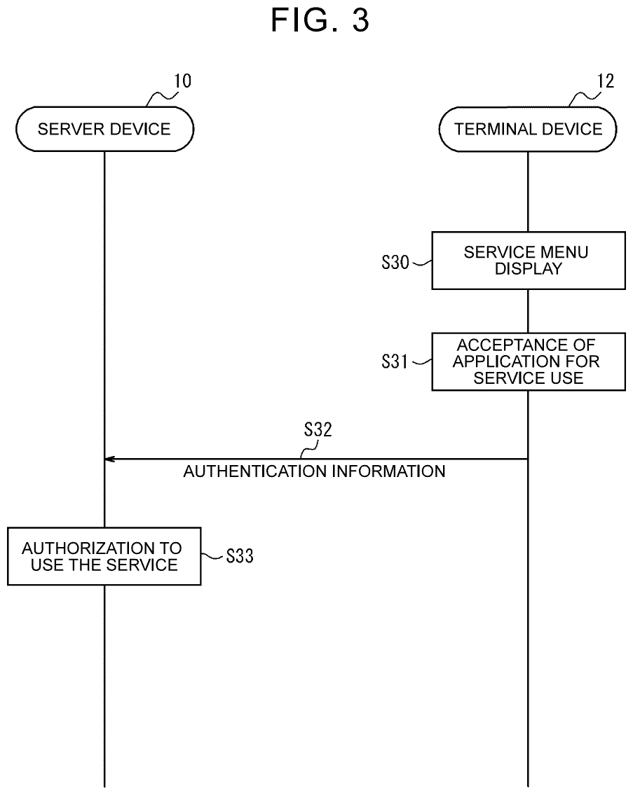

FIGS. 2 and 3 are sequence diagrams for explaining an operation procedure of the information processing system 1 according to the present embodiment. FIGS. 2 and 3 show procedures related to the linking operation of the server device 10 and the terminal device 12. Steps related to various kinds of information processing of the server device 10 and the terminal device 12 in FIGS. 2 and 3 are executed by the respective control units 103 and 123. Further, the control units 103 and 123 of the server device 10 and the terminal device 12 transmit and receive information to and from each other via the communication units 101 and 121, respectively, so that the steps related to the transmission and reception of various kinds of information of the server device 10 and the terminal device 12 are executed. In the server device 10 and the terminal device 12, information transmitted and received by the respective control units 103 and 123 is appropriately stored in the respective storage units 102 and 122. Further, in the terminal device 12, the control unit 123 receives input of various kinds of information via the input unit 125, and the output unit 126 outputs various kinds of information.

The procedure of FIG. 2 is executed when the user uses the mobile payment service using the terminal device 12. For example, when the user activates the payment application program of the terminal device 12, the procedure of FIG. 2 is executed.

In S20, the terminal device 12 performs a process for setting a payment application in response to an input by a user's operation. The terminal device 12 displays an application interface that prompts the user to input authentication information, for example, a screen for initial setting. The initial setting screen includes text information prompting input of a user name, a password, a financial account to be settled, and the like. For example, the user inputs a user name, a password, information of a financial account, and the like by a touch operation on the touch panel. The initial setting screen may include information prompting the user to present an identification card such as a license. For example, the terminal device 12 may capture an identification card with a camera, extract information from the captured image or the captured image, and include the information in the authentication information.

In S21, the terminal device 12 sends the authentication information to the server device 10. The terminal device 12 may encrypt the authentication information by an arbitrary algorithm. Identification information of the terminal device 12 is attached to the authentication information.

In S22, the server device 10 sets the payment information using the authentication information. The server device 10 stores, for example, the authentication information of the user and the identification information of the terminal device 12 in association with each other.

When S22 is executed once from S20, the user can use the payment service.

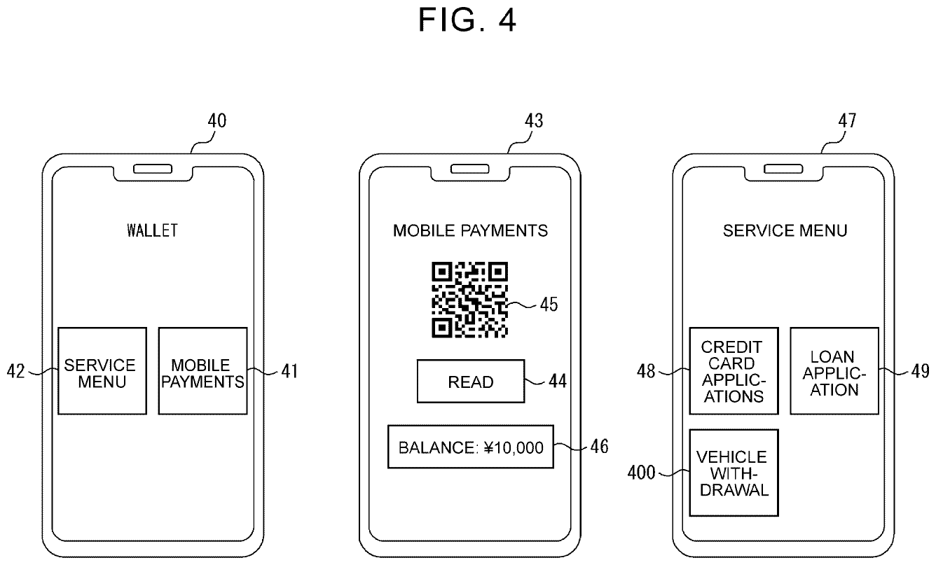

S23 to S25 are executed each time the user uses the payment service. For example, when a user performs shopping or the like at a store or the like and pays a price or the like, when the user activates a payment application program of the terminal device 12, the terminal device 12 presents an application interface for a payment service. For example, the terminal device 12 activates the main screen 40 illustrated in FIG. 4. The main screen 40 includes an operation icon 41 for selecting a mobile payment. When the user selects to execute the mobile payment by tapping the operation icon 41, S25 is executed from S23.

In S23, the terminal device 12 performs a process for executing a payment in response to an entry by the user. The terminal device 12 displays, for example, the mobile payment screen 43 of FIG. 4. The mobile payment screen 43 includes an operation icon 44 for instructing activation of the camera to read an image code such as a bar code or a QR code (registered trademark). When the user taps the operation icon 44, the terminal device 12 activates the camera, and reads, for example, an image code indicating information for specifying a store operator and performing a settlement process by the camera. The terminal device 12 sends the settlement information for the settlement process to the server device 10. The settlement information includes, for example, identification information of the store operator corresponding to the image code, information of the settlement price input by the user, and the like. Further, for example, the mobile payment screen 43 displays the image code 45 indicating the identification information of the user, and the terminal device 12 causes the terminal device of the store to read the image code 45. As a result, the settlement information including the identification information of the user, the settlement price information, and the like is sent from the terminal device of the store to the server device 10. Alternatively, the terminal device 12 may transmit and receive information necessary for settlement by near field communication with the shop terminal. The mobile payment screen 43 includes a balance display 46 indicating a current balance that can be used.

In S24, the server device 10 acquires the payment information. In response to S23, the server device 10 acquires payment data sent from the terminal device 12 or the terminal device of the store.

In S25, the server device 10 executes a payment process. The server device 10 executes a process for settling the settlement fee in the financial account of the user based on the settlement information. The settlement processing is executed in cooperation with the server of the financial institution.

The procedure of FIG. 3 is a procedure when the user selects another service by the application interface of the payment application program of the terminal device 12. When the user activates the payment application program, the terminal device 12 activates the main screen 40 illustrated in FIG. 4. The main screen 40 includes an operation icon 41 for selecting a mobile payment, and an operation icon 42 for activating a service menu of another service. When the user selects the service menu by tapping the operation icon 42, S33 is executed from S30.

In S30, the terminal device 12 presents an application interface including a service menu in response to an input by a user's operation. For example, the terminal device 12 receives the selection of the operation icon 42 and displays the service menu screen 47 of FIG. 4. The service menu screen 47 includes, for example, an operation icon 48 for making an application for a credit card service provided by a business operator, an operation icon 49 for making an application for a loan borrowing service provided by a business operator, and an operation icon 400 for making an application for a trade-in service of a vehicle.

In S31, the terminal device 12 receives a service-use application in response to an input by a user's operation. The terminal device 12 receives a selection by a tap operation of the user with respect to the operation icon 48, 49, or 400.

In S32, the terminal device 12 sends the authentication information to the server device 10. The terminal device 12 reads the authentication information stored in the storage unit 122 in S20 together with the information specifying the service corresponding to the selected operation icon 48, 49, or 400, and sends the authentication information to the server device 10. The authentication information may be encrypted by any algorithm. Further, the authentication information is attached with identification information of the terminal device 12.

In S33, the server device 10 performs a process for permitting the use of the service by using the authentication information. For example, the server device 10 identifies the user and the financial account using the authentication information of the user, and executes a process for examination for issuing a credit card. In addition, the server device 10 executes processing for loan examination by using the authentication information of the user. In addition, the server device 10 executes a process of storing identification information at the time of assessing the trade-in of the vehicle by using the authentication information of the user. These processes are executed in cooperation with other servers that provide credit information and the like.

According to the procedure described above, when using the mobile payment service, the terminal device 12 stores the authentication information when the user inputs the authentication information at a time in the application interface. Therefore, when the user requests to use another service, the authentication information stored in the terminal device 12 is sent to the server device 10 even if the user does not input the authentication information again. This allows processing for the use of other services. Therefore, a complicated time and effort in which the user inputs the authentication information a plurality of times is omitted, and the convenience of the user can be improved.

In the above description, an example in which the terminal device 12 displays an operation screen as an application interface has been described. However, the present embodiment also includes a case where the application interface is presented by outputting character information of the operation screen by voice.

Further, in the above-described embodiment, the processing program or the control program that defines the operation of the control unit 123 of the terminal device 12 may be stored in the storage unit of the server device 10 or another server device and downloaded to each terminal device 12 via the network 11. Alternatively, the processing program or the control program may be stored in a recording medium or a storage medium readable by each terminal device 12 and read from the medium by each terminal device 12.

While embodiments have been described above with reference to the drawings and examples, it is noted that various changes and modifications can be readily made by those skilled in the art based on the present disclosure. It should be noted, therefore, that these modifications and alterations are within the scope of the present disclosure. For example, the functions included in the respective means, the respective steps, and the like can be rearranged so as not to logically contradict each other. It is possible to combine or divide a plurality of means, steps, etc. into one.

What is claimed is:

1. A non-transitory storage medium storing a program for a terminal device, the program being executed by a control unit of the terminal device to cause the control unit to:
output information for an interface configured to prompt a user to use a payment service provided by a business operator;
send authentication information of the user that is input according to the interface to an information processing device configured to perform a process for the payment service; and
send the authentication information to the information processing device when another service provided by the business operator is presented on the interface and an instruction to apply for use of the other service is received.

2. The non-transitory storage medium storing the program according to claim 1, wherein the control unit is configured to store the authentication information of the user that is input for use of the payment service in a storage unit, and send the authentication information stored in the storage unit to the information processing device without receiving further input of the authentication information when the instruction to apply for the use of the other service is received.

3. An information processing device comprising:
a communication unit; and
a control unit configured to perform communication by using the communication unit, wherein the control unit is configured to:
receive, from a terminal device including an interface configured to prompt a user to use a payment service provided by a business operator, authentication information of the user that is input according to the interface, and perform a process for the payment service; and
receive the authentication information sent from the terminal device in response to an instruction to apply for use of another service provided by the business operator when the other service is presented on the interface, and perform a process for permitting the user to use the other service.

4. A method for operating a system including a terminal device and an information processing device configured to communicate with each other, the method comprising:
outputting, by the terminal device, information for an interface configured to prompt a user to use a payment service provided by a business operator, and sending authentication information of the user that is input according to the interface;
receiving, by the information processing device, the authentication information of the user and performing a process for the payment service;
sending, by the terminal device, the authentication information when another service provided by the business operator is presented on the interface and an instruction to apply for use of the other service is received by the terminal device; and
receiving, by the information processing device, the authentication information and performing a process for permitting the user to use the other service.

5. The method according to claim 4, wherein the terminal device is configured to store the authentication information of the user that is input for use of the payment service in a storage unit, and send the authentication information stored in the storage unit to the information processing device without receiving further input of the authentication information when the instruction to apply for the use of the other service is received.
